(19) United States
(12) Patent Application Publication
(10) Pub. No.: US 2003/0158883 A1
(43) Pub. Date: Aug. 21, 2003

(54) Message processing

(76) Inventors: Antoni N. Drudis, Saratoga, CA (US); Bill Serra, Palo Alto, CA (US)

Correspondence Address: HEWLETT-PACKARD COMPANY, Intellectual Property Administration, P.O. Box 272400, Fort Collins, CO, 80527-2400, US

(21) Appl. No.: 10/061,187

(22) Filed: Feb. 4, 2002

(51) Int. Cl. G06F 9/00

(52) U.S. Cl. 709/102; 709/226

(57) ABSTRACT

In distributed processing systems the distribution of messages from a message queue to the multiple processing devices is generally managed either by a queue manager or directly by each processing device. However, problems can occur where dependencies exist between messages and where it is necessary to preserve the processing order of messages. The present invention proposes an efficient method, system and apparatus for preserving the processing order of processing messages where required, whilst not unnecessarily forcing the processing order of other messages.

### FIELD OF THE INVENTION

The present invention relates to the field of distributed processing, and, more particularly, to the processing of messages in a message queue.

### BACKGROUND OF THE INVENTION

Many processing systems utilize a message queue for the temporary storage of messages from client devices prior to processing the messages in a distributed processing system. Typical distributed processing systems comprise multiple parallel processing devices which remove messages from the queue and process them accordingly. The processing devices may be, for example, program threads, servers, processors and such like. Distributed processing systems may be found in, for example, multi-threaded operating systems, telecommunications call processing systems, and credit card terminals.

Typically, client devices, such automatic teller machines, pre-paid telephone subscribers, credit card terminal readers, personal computer displays, send, or cause to be sent, messages to the message queue of a distributed processing system. The messages are held in the queue until they are removed and allocated to a processing device. The allocated processing device processes the message and, upon completion, sends an acknowledgement back to the client device which originated the message along with the requested information or the status of the transaction. To allow the origin of a message to be determined messages typically include an origin identifier. Once acknowledgement is received, the client device may then send another message to the message queue for processing.

Message processing systems typically deal with messages on an individual basis, since messages, even from the same client device, are typically independent of other messages. However, where dependencies exist between messages, or where the order of message processing must be preserved, problems can arise.

For example, if a user of an automatic teller machine (ATM) performs several transactions the transactions must generally be processed in the order they were made: if the user makes a deposit followed by a withdrawal the account may have sufficient funds, however if the message processing system processes the withdrawal before the deposit the user may be informed that the account has insufficient funds. However individual transactions, for example, just a withdrawal, do not need to be processed in any specific order.

Similarly, in some telecommunications environments, for example in a pre-paid telephony system, it is required that the order in which messages originating from each client are processed is preserved. Consider the following example in which a message is sent from a client device to credit a pre-paid account. Immediately afterwards a message is sent, following the termination of a telephone call, to debit the pre-paid account. If the message to debit the account is processed prior to the message to credit the account, the user may be denied the ability to make a telephone call due to lack of credit.

One way of addressing the issues would be to force the processing of all messages from certain client devices to specified processing devices, for example, by sending all the transactions from a certain ATM to the same processing device. Although this ensures that the order of message processing is preserved, it is not an efficient solution. For example, if one client device is very active, and another client device is not being used, this would result in one of the processing devices being busy, whilst another remains idle. Similarly, where the processing order of messages is not critical, such solutions place unnecessary burdens on distributed processing systems.

Accordingly, one aim of the present invention is to provide improved message processing systems and methods.

### SUMMARY OF THE INVENTION

According to a first aspect of the present invention, there is provided a distributed processing method for processing messages in a queue, wherein the queue can accommodate a plurality of messages, each message having an identifier identifying the origin of the message and wherein the processing of the messages is performed by a plurality of processing devices, comprising: allocating a message from the queue for processing by an available processing device; determining whether other messages having the same identifier are concurrently allocated to other ones of the plurality of processing devices; and where it so determined, waiting for the determined other messages to be processed, prior to processing the allocated message.

The present invention is based on the realization that, in a message processing system, there is not necessarily a requirement to track messages from all clients in a system, only those which require the processing order to be preserved. For instance, in many applications there is no need to keep track of all past messages from a user or client device, and in telecommunications applications there is not even any need to track all messages from the same call, but only to keep track of messages being processed while other messages having the same origin identifier are being processed or are pending being processed. Furthermore, processing efficiency is improved.

According to a second aspect of the present invention, there is provided a distributed processing system for processing messages in a queue.

According to a third aspect of the present invention, there is provided a processing device for use in a distributed processing system, comprising: a processor for allocating a message from the queue for processing by an available processing device; a comparator for determining whether other messages having the same identity are concurrently allocated to other ones of the plurality of processing devices; and where it so determined, means for waiting for the determined other messages to be processed, prior to processing the allocated message.

According to a fourth aspect of the present invention, there is provided a distributed processing method for processing messages in a queue, wherein the queue can accommodate a plurality of messages, each message having an identifier identifying the origin of the message and wherein the processing of the messages is performed by a plurality of processing devices, comprising: allocating a message from the queue for processing by an available processing device; maintaining record of messages allocated to the plurality of processing devices; determining, from the maintained record, whether other messages having the same identity are concurrently allocated to other ones of the plurality of processing devices; and where it so determined, waiting for the determined other prior message(s) to be processed, prior to processing the allocated message.

According to a fifth aspect of the present invention, there is provided an article of manufacture comprising a program storage medium having computer readable program code means embodied therein for performing a method of controlling the processing of messages in a message queue of a distributed processing system, wherein the queue can accommodate a plurality of messages, each message having an identifier identifying the origin of the message and wherein the processing of the messages is performed by a plurality of processing devices, the computer readable program code means in the article of manufacture including: computer readable program code means for causing a computer to allocate a message from the queue for processing by an available processing device; computer readable program code means for causing a computer to determine whether other messages having the same identity are concurrently allocated to other ones of the plurality of processing devices; and computer readable program code means for causing a computer to, where it so determined, wait for the determined other messages to be processed, prior to processing the allocated message.

### BRIEF DESCRIPTION OF THE INVENTION

The invention will now be described, by way of non-limiting example, with reference to the accompanying drawings, in which

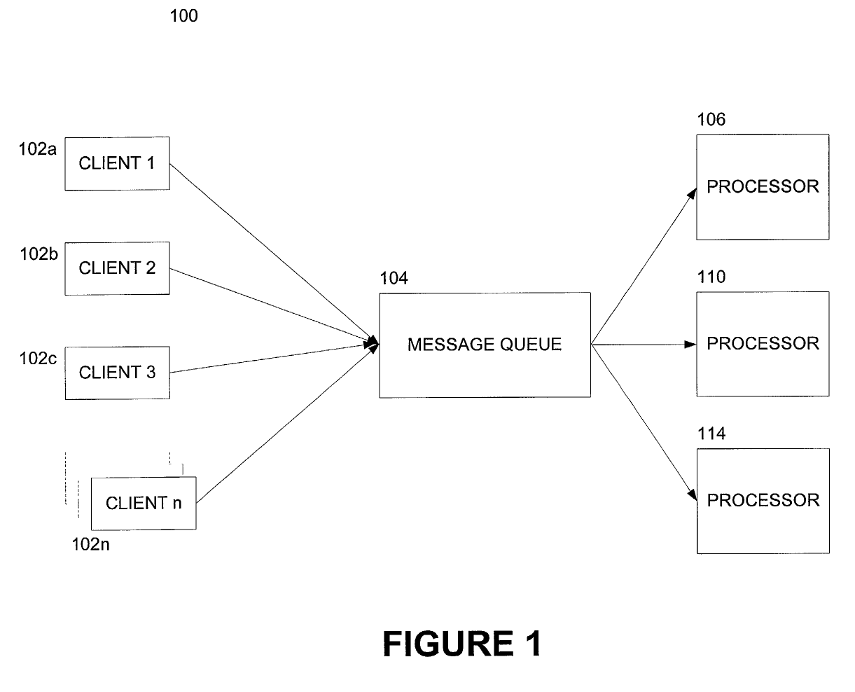

FIG. 1 is a block diagram showing a typical example of a message processing system 100 according to the prior art;

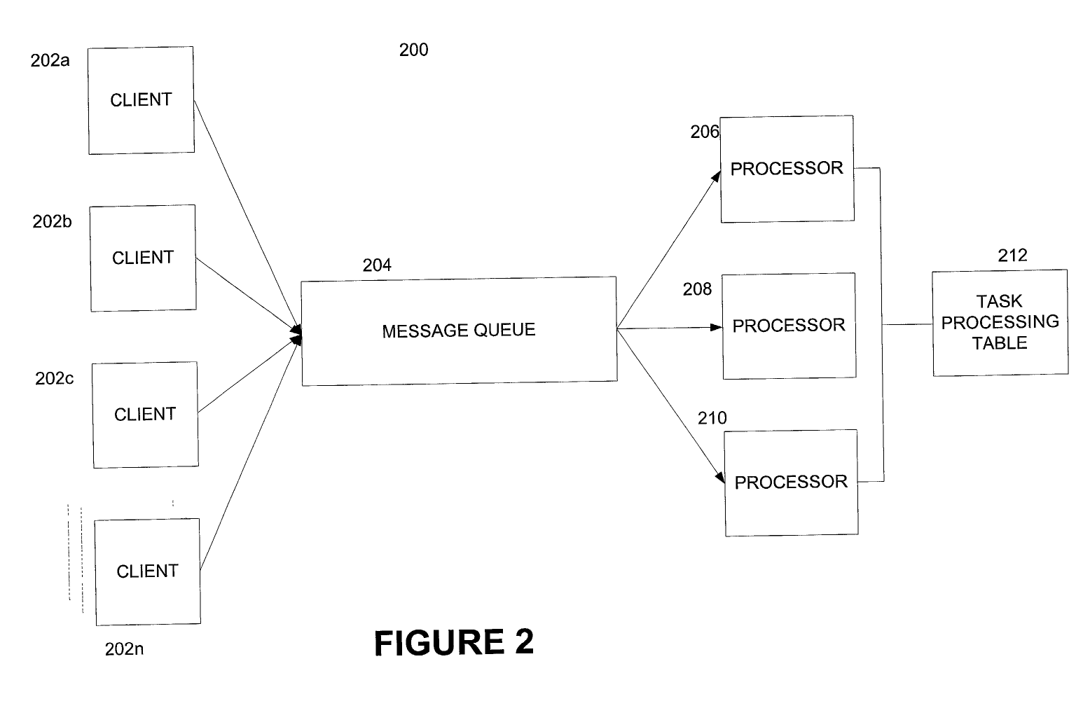

FIG. 2 is a block diagram showing a message processing system according to an embodiment of the present invention;

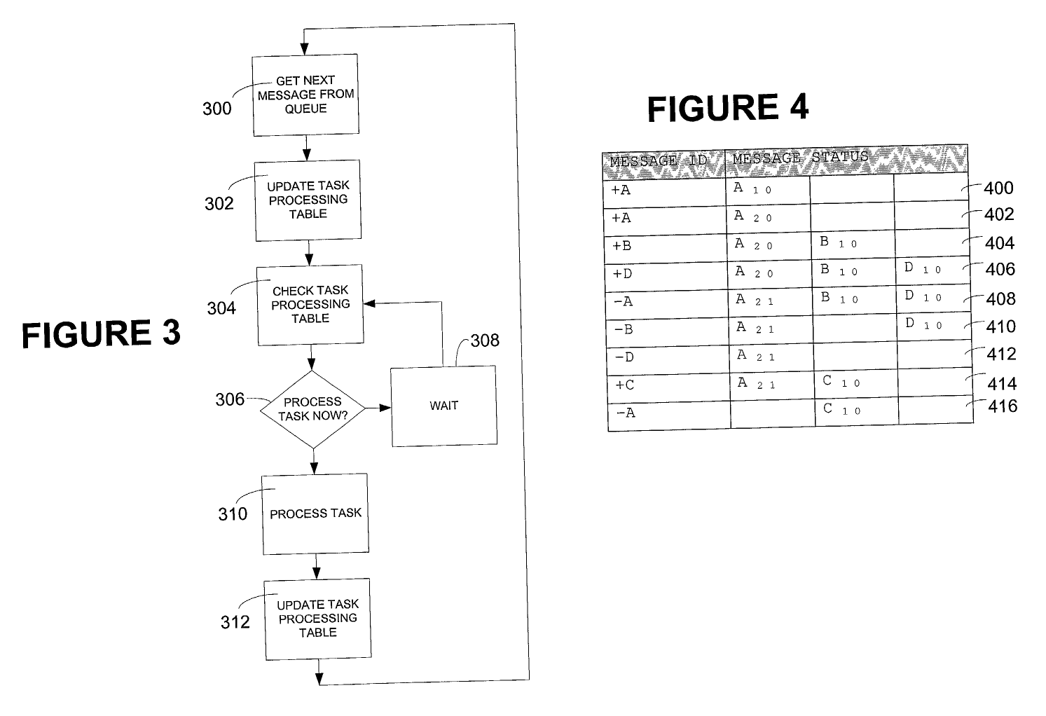

FIG. 3 is a flow diagram showing an example of the steps taken by a processing device according to an embodiment of the present invention; and

FIG. 4 is a table showing an example representation of a task processing table according to an embodiment of the present invention.

### BEST MODE OF CARRYING OUT THE INVENTION

FIG. 1 is a block diagram showing a typical implementation of a generic message processing system according to the prior art. The message processing system could, for instance, be part of a telecommunications call processing system, a multithreaded operating system, or a bank processing system.

A number of different clients 102a to 102n transmit messages to be processed to a message queue 104. The message queue acts as a buffer to store the messages typically in the order or arrival or, alternatively, according to other parameters, such as priority level. Messages are removed from the message queue and allocated to one of the available processing devices 106, 110 and 114 for processing. Once a processing device has finished processing a message an acknowledgement is sent back to the client device which originated the message along with the requested information or the status of the transaction.

Typically, a client device will wait for acknowledgement of the completion of the processing of a previous message before sending a further message to the message queue. However, situations can arise, for example due to a malfunction, where multiple messages are sent to the message queue or where messages are re-sent following the failure to receive an acknowledgement from the message processing system.

As already stated, most messages received in the message queue are independent of one another and the order in which the messages are processed relative to each other is not important. Additionally, for example, in pre-paid telephony, multiple messages may be issued from a single client device. For example, if the transmission medium through which messages are sent from the client devices to the message queue is unreliable, the system can be designed to duplicate messages and to distribute the messages through different channels. This relies on the message processing system recognising and removing duplicate messages. Even where a reliable transmission medium is used the client devices may transmit duplicate or additional messages if an acknowledgement expected for a previous message is not received by the client device within a given delay.

Although the occurrence of such multiple messages from a single client may be infrequent, the huge number of clients served by typical telecommunications networks can result in significant numbers of such occurrences happening. The message processing system therefore needs to maintain the processing order of related messages, but is not required to preserve the order of processing of other, unrelated, messages. Therefore, schemes which force the processing of all messages in order are unnecessary and inefficient when only the processing order of some of the messages need be preserved. What is required is an efficient scheme which ensures that the processing order of messages is preserved without imposing undue burden on the processing system.

FIG. 2 is a block diagram showing such a message processing system 200 according to an embodiment of the present invention. The message processing system 200 could form part of a telecommunications network call processing system or alternatively could be used in any distributed processing system.

A number of client devices 202a to 202n send messages to a message queue 204. In a telecommunication system the clients devices could be pre-paid telephone users. In a prepaid telephony system, the telecommunications network keeps a track of the calls through a sequence of messages which describe the interaction of the user with their telephone handset. Such messages can, for instance, include hang-up, dial a number and such like. These messages need to be processed in the order in which they are generated, but there is no need to force the processing of other messages from other client devices in the same sequence

The messages sent to the message queue include an origin identifier for identifying the client device which sent the message. Messages are removed from the message queue 204 by a number of processing devices 206, 208 and 210. The processing devices may be separate threads running on a common platform, or may be independent processors, servers, computers, or such like.

In order to preserve the order of message processing a task processing table 212 is provided which is accessible by each of the processing devices 206, 208 and 210. The task processing table 212 is used to keep a track of current messages being processed, and also the order, if any, in which messages should be processed, as will be described further below. The task processing table may, for example, be held in a database, or an area of shared memory, as appropriate.

An example embodiment of the proposed message processing scheme will now be described with reference to FIG. 3.

FIG. 3 is a flow diagram showing an example of the steps taken by a processing device according to one embodiment.

A processing device, for example the processing device 206, removes a message from the message queue 204, represented by step 300. The processing device 206 updates the task processing table 212, step 302, to indicate that a new message has been removed from the queue. Further details of the task processing table are given below with reference to FIG. 4.

The processing device checks, using a comparator which can be any suitable comparison function, step 304, the task processing table 212 to determine, step 306, whether it can process the message immediately, step 310, or whether it has to wait, step 308, whilst another message or messages having the same origin identifier is/are processed by another on the processing devices. This ensures that the processing order of messages having the same origin identifier is preserved.

Once the message has been processed, the processing device updates the task processing table 212, step 312, to indicate that the message has been processed. The processing device is then ready to get the next available message from the message queue 204.

FIG. 4 is a table showing an example representation of a task processing table according to one embodiment. In the left-hand column of FIG. 4, ‘+A’ indicates the removal of a message having origin identifier ‘A’ (hereinafter referred to as an ‘A’ message) from the message queue by a processing device. ‘−A’ indicates the completion of processing of an ‘A’ message by a processing device. The remaining columns represent the processing status of the various messages, as explained below, and use the following nomenclature; X_{yz}, where X is message having the origin identifier X, where y is the number of messages having the same origin identifier currently pending processing, and where z is the number of such messages actually processed.

Row 400 of FIG. 4 shows the removal of an ‘A’ message from the message queue by one of the processing devices, for example the processing device 106. Since no entries exist in the table, a new entry is created, A_{1 0}, to indicate that one ‘A’ message is pending processing, and no ‘A’ messages have been processed. Since no previous entries existed for ‘A’ messages, the processing device 106 starts processing the message.

Row 402 shows the removal of a further ‘A’ message from the message queue by another one of the processing devices, for example the processing device 110. The current value of the A_{y} value is stored to indicate the order in which the message must be processed. The processing device 110 updates the task processing table to A_{2 0}, which indicates that 2 messages are pending processing, and none have been processed yet. To ensure that the ‘A’ messages are processed in the correct order, the processing device 110 can only process its current message when the stored A_{y} value is equal to the A_{z} value.

Rows 404 a 406 show the removal of ‘B’ and ‘D’ messages and the corresponding entries in the task processing table. At row 408, the first ‘A’ message is processed, and the task processing table is updated accordingly. The processing device 110 can now process its ‘A’ message, since the A_{y} value it stored is now equal to the number of ‘A’ messages processed.

Row 410 shows the completion of processing of the only pending ‘B’ message, and the table entry is therefore removed from the task processing table 212.

It can be seen that the task processing table provides an efficient way of managing the message processing, by ensuring the processing order of messages having the same origin identifier is preserved, whilst not imposing processing restrictions on other messages.

In one embodiment, processing devices waiting to process a message poll or interrogate the task processing table regularly to see whether the preceding messages have been processed and the task processing table has been updated. In a preferred embodiment the task processing table informs each processing devices whenever a message has been processed, thereby prompting the processing device to check the task processing table to identify whether a message pending processing may be processed. In an alternative embodiment, the task processing table can also contain details of which processing devices are processing which messages, and therefore can inform the relevant pending processing device whenever an associated message, i.e. a message having the same origin identifier as another message, has been processed.

In the worst-case scenario, all the processing devices will have messages having the same origin identifier pending whilst one of the messages is being processed. In this case, one processing device is actually processing, whilst all the others are idle. However, in normal operation this situation is extremely unlikely to occur

Processing delays are most likely to occur when the processing devices need to access external resources, for example, such as customer databases, voice mail systems. Such delays can be due to, for example, network delays or problems with the external resources.

It is therefore preferable for each processing device to use a timeout period so that, if for any reason a processing device fails to complete the processing of message, for example because of a software or hardware fault, other processing devices will not wait indefinitely. For example, if a timeout of 10 seconds is used, any message not processed within 10 seconds will be indicated as having been processed in the task processing table. This will ensure the processing order in case one of the processing devices crashes or is unable to process a message within the timeout period.

Although the present invention has been described above with reference primarily to pre-paid telecommunications environments to which the technique is particularly suited, those skilled in the art will appreciate that the techniques described are not limited for use solely within telecommunications environments. The techniques described herein may equally be applied to other environments whereby the order of message processing is required to be preserved, for example in bank transaction processing systems, multi-threaded operating systems and such like.

1. A distributed processing method for processing messages in a queue, wherein the queue can accommodate a plurality of messages, each message having an identifier identifying the origin of the message and wherein the processing of the messages is performed by a plurality of processing devices, comprising:
allocating a message from the queue for processing by an available processing device;
determining whether other messages having the same identifier are concurrently allocated to other ones of the plurality of processing devices;
and where it so determined, waiting for the determined other messages to be processed, prior to processing the allocated message.

2. The method of claim 1, wherein the step of determining comprises maintaining, in a form accessible to the plurality of processing devices, a record of messages allocated to the processing devices.

3. The method of claim 2, further comprising, whilst waiting for prior messages to be processed, periodically interrogating the record of messages to determine whether the prior messages have been processed, thereby allowing processing of the current message to be effected.

4. The method of claim 2, wherein the step of maintaining further includes the step of informing the processing devices was a message has been processed.

5. The method of claim 1, wherein each processing device has a predefined timeout period, thereby limiting the amount of time a processing device will wait prior to processing a message.

6. A distributed processing system for processing messages in a queue in accordance with the method of claim 1.

7. A telecommunications network comprising a distributed processing system according to claim 6.

8. A processing device for use in a distributed processing system according to claim 6, comprising:
a processor for allocating a message from the queue for processing by an available processing device;
a comparator for determining whether other messages having the same identity are concurrently allocated to other ones of the plurality of processing devices; and where it so determined, means for waiting for the determined other messages to be processed, prior to processing the allocated message.

9. A processing device for use in a distributed processing system according to claim 6, comprising:
means for allocating a message from the queue for processing by an available processing device;
means for determining whether other messages having the same identity are concurrently allocated to other ones of the plurality of processing devices; and where it so determined, means for waiting for the determined other messages to be processed, prior to processing the allocated message.

10. A distributed processing method for processing messages in a queue, wherein the queue can accommodate a plurality of messages, each message having an identifier identifying the origin of the message and wherein the processing of the messages is performed by a plurality of processing devices, comprising:
allocating a message from the queue for processing by an available processing device;
maintaining record of messages allocated to the plurality of processing devices;
determining, from the maintained record, whether other messages having the same identity are concurrently allocated to other ones of the plurality of processing devices;
and where it so determined, waiting for the determined other prior message(s) to be processed, prior to processing the allocated message.

11. An article of manufacture comprising a program storage medium having computer readable program code means embodied therein for performing a method of controlling the processing of messages in a message queue of a distributed processing system, wherein the queue can accommodate a plurality of messages, each message having an identifier identifying the origin of the message and wherein the processing of the messages is performed by a plurality of processing devices, the computer readable program code means in the article of manufacture including:
computer readable program code means for causing a computer to allocate a message from the queue for processing by an available processing device;
computer readable program code means for causing a computer to determine whether other messages having the same identity are concurrently allocated to other ones of the plurality of processing devices; and
computer readable program code means for causing a computer to, where it so determined, wait for the determined other messages to be processed, prior to processing the allocated message.
